(19) United States
(12) Patent Application Publication
(10) Pub. No.: US 2001/0042590 A1
(43) Pub. Date: Nov. 22, 2001

(54) Method and device for making a magnetically mountable substrate construction form a selected substrate

(76) Inventor: Carl D. Neuburger, Scottsdale, AZ (US)

Correspondence Address: PILLSBURY WINTHROP LLP, 1600 TYSONS BOULEVARD, MCLEAN, VA, 22102, US

(21) Appl. No.: 09/827,943

(22) Filed: Apr. 9, 2001

Related U.S. Application Data
(60) Provisional application No. 60/197,684, filed on Apr. 17, 2000.

(51) Int. Cl. B32B 31/00

(52) U.S. Cl. 156/250; 156/269; 156/289

(57) ABSTRACT

The present application relates to a method and device for making a magnetically mountable substrate construction from a selected substrate for magnetic mounting to a structure including magnetizable material.

The present application claims priority to U.S. Provisional Application of Neuburger, Ser. No. 60/197,684, filed Apr. 17, 2000, the entirety of which is hereby incorporated into the present application.

### FIELD OF THE INVENTION

The present invention relates to a method and device for making a magnetically mountable substrate construction from a selected substrate for magnetic mounting to a structure including magnetizable material.

### BACKGROUND OF THE INVENTION

The use of magnets for mounting substrates to structures including magnetizable material is well-known. Probably the most widely known use of such magnets are refrigerator magnet constructions which are used to support papers and the like on the steel door of a refrigerator. Oftentimes, these magnet constructions are pre-made with a decorative front to enhance their appearance on the refrigerator door. The backing is formed from a rigid or flexible material that includes permanently magnetized material therein. The permanently magnetized material enables the magnet construction to be magnetically mounted to the steel refrigerator door because the steel itself is a temporarily magnetizable material.

Oftentimes, persons in the arts and crafts field desire to make their own magnets. That is, they desire to make a magnet construction with a decorative front of their own choosing. For example, a person may desire to make a magnet construction with the front being a picture of their children or pet. Such a “homemade” magnet construction has a personalized feel that cannot be obtained by purchasing a pre-made magnet construction.

To this end, there have been provided devices that enable such persons to make magnets with decorative fronts of their own selection. One example of such a device comes in the form of pre-made sheets of magnet substrate that includes permanently magnetized material. These sheets are sold in a flat form and are coated with a layer of pressure-sensitive adhesive, which is covered by a silicone coated release liner to protect the adhesive. To use the sheet, the user simply peels off the flexible release liner and discards the same; engages a selected substrate (such as a photograph) with the adhesive layer and applies sufficient pressure thereto to adhesively bond the selected substrate to the magnet substrate; and then cuts or trims the magnet substrate around the periphery of the selected substrate. The resulting magnetically mountable substrate construction can then be mounted to a refrigerator door or some other structure including magnetizable material. While this type of device has seen some commercial success, it is not particularly suitable for repeated production of a number of these home-made magnet constructions.

One device known in the art provides for more efficient production of such magnetically mountable substrate constructions. This device comprises a cartridge having a roll of flexible magnet substrate with a layer of adhesive on one side thereof wound about a core and a roll of flexible protecting substrate wound about another core. The cores are rotatably mounted in a cartridge body structure, which removably mounts to an apparatus constructed in accordance with the teachings of U.S. Pat. No. 5,580,417 and the further patents/applications that claim priority thereto. The '417 patent is hereby incorporated into the present application in its entirety for all purposes.

To use this cartridge-type device, the cartridge is removably mounted to the apparatus and the lead ends of the substrates are fed in between the cooperating pressure applying structures of the apparatus, which are usually in the form of counter-rotating nip rollers. The user can then feed the selected substrate into the cooperating pressure applying structures between the lead end portions of the magnet and protecting substrates and then operate the apparatus to affect rotation of the cooperating structures. As the cooperating structures rotate, they apply pressure to the substrates to cause the adhesive to adhesively bond the selected substrate to the magnet substrate and then they discharge the substrates outwardly therefrom. The user can then cut off the discharged substrates and trim around the periphery of the selected substrate. The protecting substrate prevents any adhesive on the magnet substrate from contacting the cooperating structures and sticking thereto. The protecting layer is usually transparent and can also be left over the selected substrate after trimming to protect the selected substrate in a fashion similar to a laminated document. This is done by leaving a marginal portion of the magnet substrate exposed during trimming so that the trimmed protecting substrate can remain bonded to the adhesive on that marginal portion.

One drawback to this device is that a release liner must be wound up along with the magnet substrate to prevent the adhesive from bonding to the opposite surface of the release liner. As the magnet substrate is unwound, the flexible magnet substrate is unwound therewith and pays out on the side opposite the adhesive to prevent it from interfering with the magnet making operation. This release liner introduces a significant cost that it would be greatly desirable to eliminate. Specifically, the release liner not only introduces an additional material cost that does not enhance the user's end product, it also introduces additional steps and equipment that increase the costs of making the cartridge. Specifically, to make the roll on which the magnet substrate is wound, the release liner must be supported on a spool separate from the spool on which the magnet substrate is supported. Then the magnet substrate is unwound, adhesive is applied to the magnet substrate, and then the magnet substrate and the release liner are wound together onto a core for installation into the cartridge.

Consequently, there exists a need in the art for a less expensive way by which home-made magnetically mountable substrate construction can be made.

### SUMMARY OF THE INVENTION

To meet the above-described need, one aspect of the present invention provides a device for making a magnetically mountable substrate construction from a selected substrate for magnetic mounting to a structure including magnetizable material. The device comprises a flexible magnet substrate having an adhesive carrying surface and a release surface opposite the carrying surface. The flexible magnet substrate includes permanently magnetized material which enables the flexible magnet substrate to be magnetically mounted to structures including magnetizable material. A layer of pressure-sensitive adhesive is provided on the adhesive carrying surface of the flexible magnet substrate. The flexible magnet substrate is wound into a roll such that the layer of pressure-sensitive adhesive directly engages the release surface of the flexible magnet substrate. The adhesive carrying surface has a greater affinity for adhesive bonding than the release surface so as to enable the device to be used to make the magnetically mountable substrate construction comprising the selected substrate, a carrier portion of the flexible magnet substrate, and a portion of the adhesive layer adhesively bonding the selected substrate to the portion of the flexible magnet substrate by (a) unwinding a lead end portion of the flexible magnet substrate with the adhesive remaining bonded to the adhesive carrying surface of the unwound lead end portion, (b) engaging the selected substrate with the adhesive on the unwound lead end portion and applying pressure to adhesively bond the selected substrate to the unwound lead end portion, and (c) cutting the unwound lead end portion so as to form the carrier portion.

Another aspect of the invention provides a method for making a magnetically mountable adhesive construction from a selected substrate for magnetic mounting to a structure including magnetizable material, the substrate construction comprising the selected substrate, a carrier portion formed from a flexible magnet substrate including permanently magnetized material, and adhesive adhesively bonding the selected substrate to the carrier portion. The method comprises:

providing a device comprising:

a flexible magnet substrate having an adhesive carrying surface and a release surface opposite the carrying surface, the flexible magnet substrate including permanently magnetized material which enables the flexible magnet substrate to be magnetically mounted to structures including magnetizable material;

a layer of pressure-sensitive adhesive provided on the adhesive carrying surface of the flexible magnet substrate;

the flexible magnet substrate being wound into a roll such that the pressure-sensitive adhesive layer directly engages the release surface of the flexible magnet substrate;

the adhesive carrying surface having a greater affinity for adhesive bonding than the release surface to enable a lead end portion of the flexible magnet substrate to be unwound with the adhesive remaining bonded to the adhesive carrying surface of the unwound lead end portion;

unwinding the lead end portion of the flexible magnet substrate with the adhesive remaining bonded to the adhesive carrying surface of the unwound lead end portion;

engaging the selected substrate with the adhesive on the unwound lead end portion of the flexible magnet substrate;

applying pressure to adhesively bond the selected substrate to the unwound lead end portion; and

cutting the unwound lead end portion of the flexible magnet substrate so as to separate the carrier portion.

Other objects, features, and advantages of the present invention will become apparent from the following detailed description, the accompanying drawings, and the appended claims.

### BRIEF DESCRIPTION OF THE DRAWINGS

FIG. 1 is a cross-sectional view of a roll made in accordance with the principles of the present invention;

FIG. 2 is a perspective view of a selected substrate mounted onto a lead end portion of the roll in FIG. 1;

FIG. 3 is a perspective view similar to FIG. 2, but showing cutting the unwound lead end portion of the roll in FIG. 1;

FIG. 4 is a side view of the magnetically mountable substrate construction;

FIG. 5 is a perspective view of a processing apparatus with a cartridge body structure constructed and arranged to mount thereto;

FIG. 6 is a perspective view of the apparatus with the cartridge body structure removably mounted thereto to affect a processing operation and showing the selected substrate inserted between the flexible magnet substrate and a flexible protecting substrate;

FIG. 7 is a perspective view of the apparatus with individual feed rolls mounted thereto; and

FIG. 8 is a perspective exploded view of one end of the core having a pre-tensioning brake thereon.

### DETAILED DESCRIPTION OF THE INVENTION

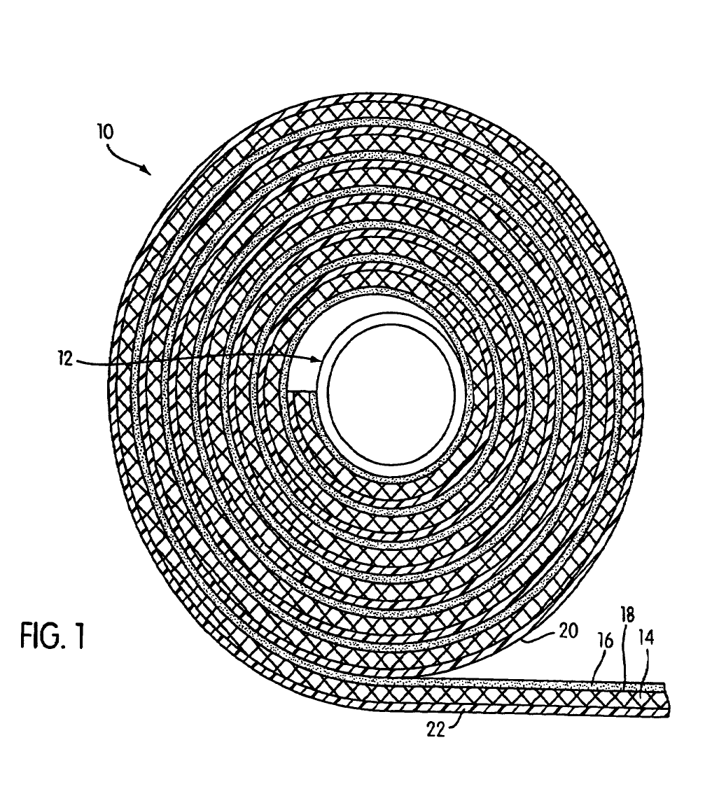

FIG. 1 is a cross sectional view of a device in the form of a roll, generally indicated at 10, embodying the principles of the present invention. The scaling of the cross-sectional view is exaggerated in order to more clearly illustrate the principles of the present invention and the arrangement of the substrates and layers. The roll 10 comprises a core 12, a flexible magnet substrate, generally indicated at 14, and a layer of pressure-sensitive adhesive, generally indicated at 16. The flexible magnet substrate 14 includes permanently magnetized material which enables the flexible magnet substrate to be magnetically mounted to structures including magnetizable material, such as steel or ferritic materials. The flexible magnet substrate 14 has an adhesive carrying surface 18 and a release surface 20 on opposite sides thereof. The layer of pressure-sensitive adhesive 16 is bonded to the adhesive carrying surface 18, which is preferably left uncoated prior to application of the adhesive, so that the entire magnet substrate 14 is covered. The pressure-sensitive adhesive 16 is formed from a suitable adhesive having relatively strong and durable bonding qualities suitable for extended periods of use, such as acrylic-based emulsion, a rubber based adhesive or any other suitable adhesive.

The core 12 may be made from paper, cardboard, plastic, or any other suitable material. Also, the core 12 may take any cross-sectional shape or configuration. In fact, it is within the scope of the invention to eliminate the core in certain situations and simply wind the magnet 14 about itself.

The flexible magnet substrate 14 is formed from a flexible matrix material such as extruded and cured rubber or the like, having a plurality of rare earth particles embedded therein via the extrusion process. After the magnet substrate 14 has been cured, it is then subject to a strong magnetic field to permanently magnetize the rare earth particles thereof. Ferritic particles may be used in place of rare earth.

The release surface 20 of the flexible magnetic substrate 14 is provided by a layer of release material 22 which has a lower affinity for adhesive bonding than the adhesive carrying surface 18. The release material 22 is preferably a low friction material, such as silicone or a wax based coating, to provide the release surface 20 with its relatively lower affinity for adhesive bonding than the adhesive carrying surface 18. Alternatively, a low friction material may be co-extruded with the matrix material (with the rare earth embedded therein). Thus, in a broad sense, the magnet substrate 14 can be considered to have a release surface 20 which is provided by either a low friction coating applied to the substrate 14 or low friction material extruded as part of the substrate 14 itself.

The flexible magnetic substrate 14 with the pressure-sensitive adhesive 16 thereon is wound about the core 12 such that the layer of adhesive 16 directly engages the release surface 20 of the substrate 14 to protect the adhesive layer 16 from exposure and accidental contact.

Because the adhesive carrying surface 18 has a greater affinity for adhesive bonding than the release surface 20, the adhesive 16 can be moved away from the release surface 20 without removing the adhesive 16 from the carrying surface 18 during unwinding of a lead end portion 24 of the substrate 14.

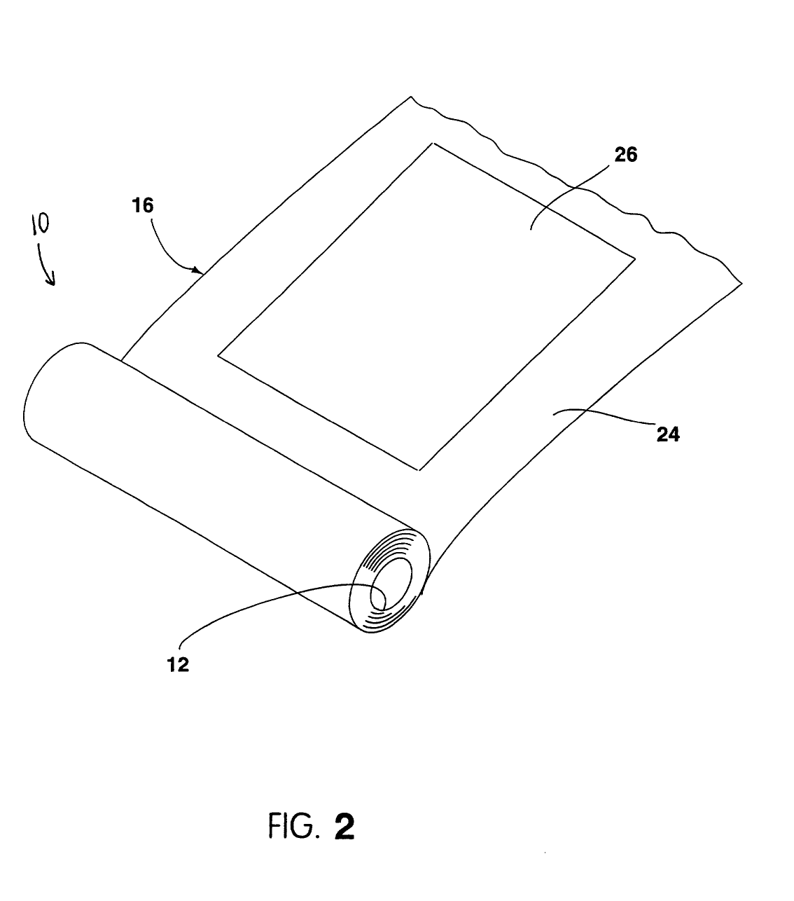

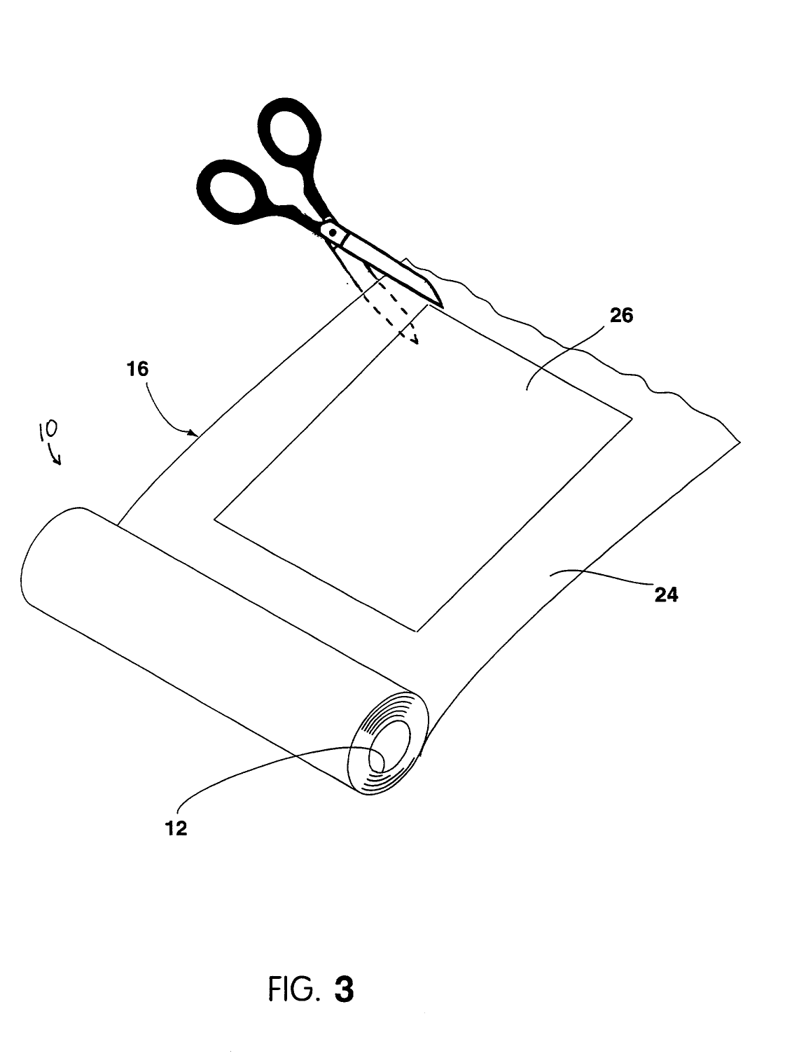

FIGS. 2-4 show sequential acts of a roll 10 designed in accordance with the principles of the present invention being used to make a magnetic mountable substrate construction for magnetic mounting to a structure including magnetizable material. A lead end portion 24 of the flexible magnet substrate 14 is unwound from the core 12 such that the selected substrate 26 may be engaged with the layer of adhesive 16 on the unwound lead end portion 24. Sufficient pressure is then applied to the selected substrate 26 to cause the adhesive 16 to adhesively bond the selected substrate 26 to the unwound lead end portion 24. As shown in FIG. 3, the flexible magnet substrate 14 has the selected substrate 26 bonded thereto may be cut by a user about the periphery of the selected substrate 26 so as to separate the completed magnetically mountable substrate construction. Alternatively, the magnet substrate 14 may be cut to the desired size before engaging the selected substrate 26 with the adhesive 16.

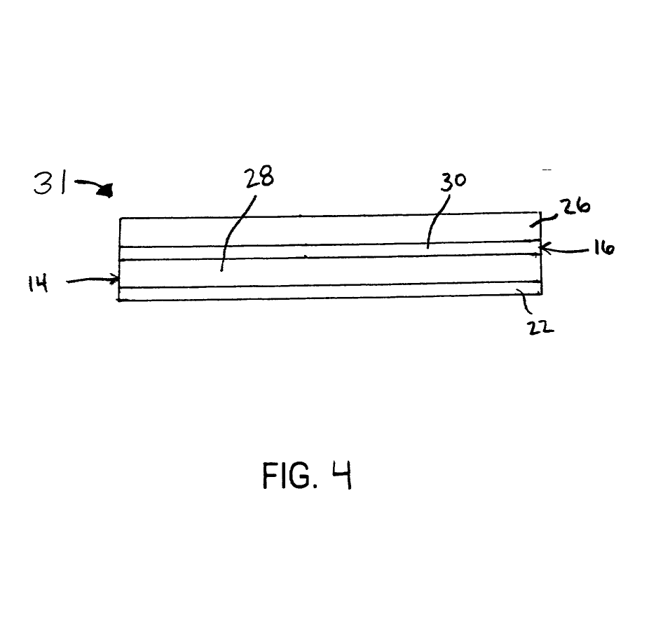

FIG. 4 shows a side view of the magnetically mountable substrate construction 31. The scaling of the elements shown in FIG. 4 is greatly exaggerated for clarity purposes. The selected substrate 26 is adhesively bonded by a portion 30 of the adhesive layer 16 to a carrier portion 28 of the flexible magnetic substrate 14. The adhesive 16 covers the entire backside of the selected substrate 26.

In the Figures, the selected substrate 26 illustrated may be a photograph. However, it is contemplated that a wide variety of selected substrates may be used with the device 10 of the present invention. For example, it may be desirable to perform a magnetic mounting operation on business cards, greeting cards, holiday decorations, school projects or pictures, arts and crafts projects, etc.

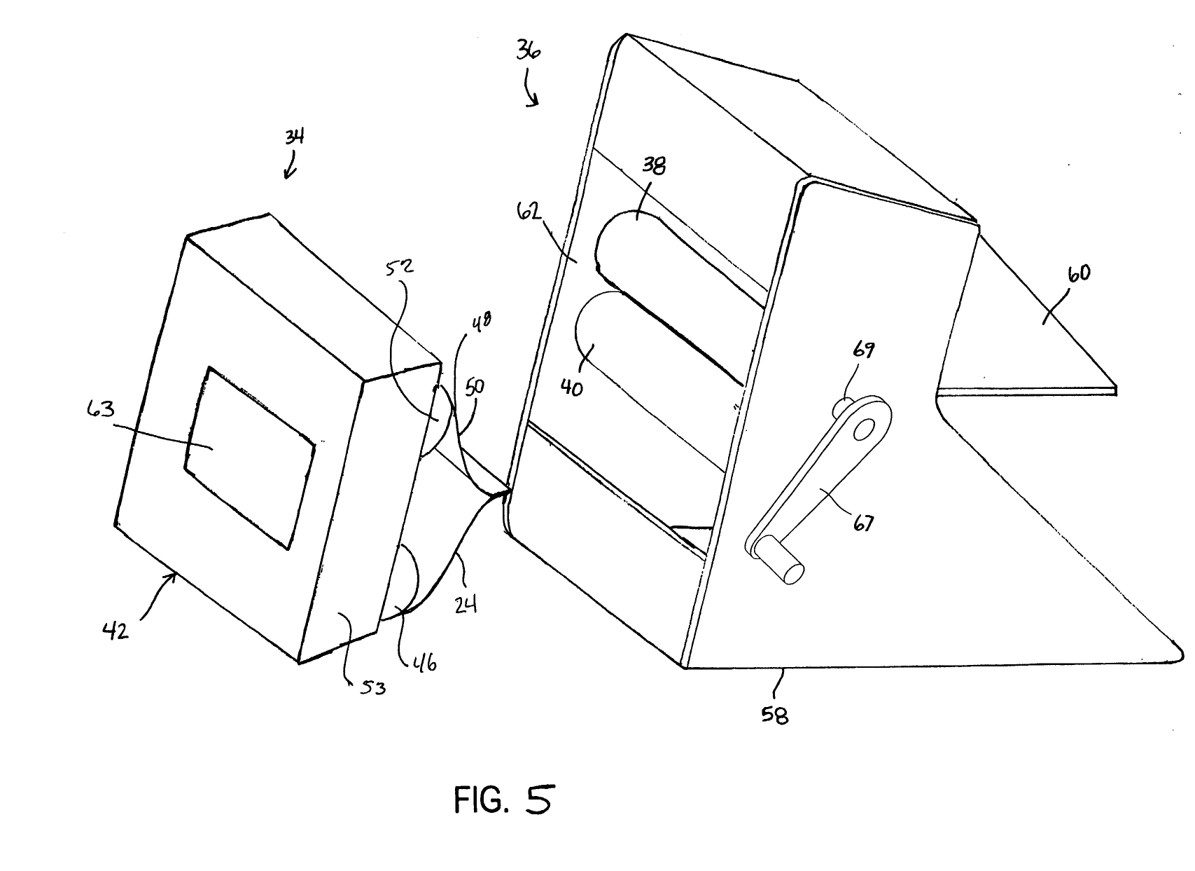

FIG. 5 shows a processing apparatus 36 that can be used for more efficient production of magnetically mountable adhesive constructions. In FIG. 5, the device of this aspect of the invention comprises a removable cartridge, generally indicated at 34, that is constructed and arranged to be removably mounted to the frame of the processing apparatus 36. The processing apparatus 36 includes cooperating pressure applying structures 38, 40 operable to apply pressure to substrates fed therebetween. In the illustrated embodiment, the cooperating structures 38, 40 are a pair of counter-rotating nip rollers, but any suitable structural arrangement for applying pressure to substrates may be used.

The cartridge 34 comprises a cartridge body 42, the core 12, and a second core 44. As described above, the flexible magnetic substrate 14 having the release material 22 coated thereon and the pressure-sensitive adhesive 16 adhered thereto is wound about the core 12 to form a lower supply roll 46. A flexible protecting substrate 48 having a lead end portion 50 is wound about the second core 44 to form an upper supply roll 52. Preferably, the protecting substrate 48 is a transparent plastic sheet that has an affinity for bonding with the adhesive 16. However, any type of material which will protect the selected substrate, such as various synthetic materials or the like, may be used in place of the transparent plastic sheet. Alternatively, the protecting substrate 48 may be release coated so that it does not adhere to the adhesive 16 and is used simply to protect the adhesive during making of the magnetically mountable substrate construction.

The supply rolls 46, 52 extend transversely between the opposing side walls, one of which is shown at 53 of the cartridge body 42. The supply rolls 46, 52 are rotatably mounted to the cartridge body 42, which enables the lead end portions 24, 50 of the respective substrates of each core 12, 44 to be unwound as shown in FIG. 5. and then fed in between the pressure applying structures 38, 40.

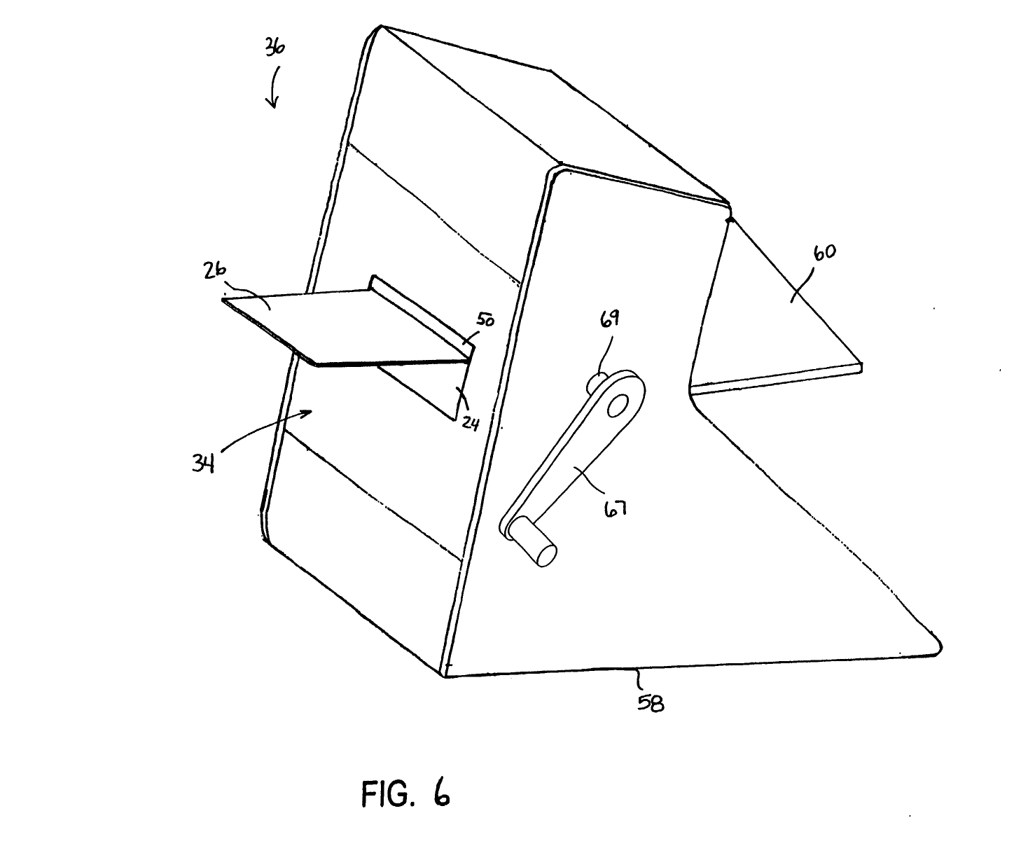

FIG. 6 illustrates a perspective view of the processing apparatus 36 with the removable cartridge 34 of the present invention removably mounted thereto. It is to be understood that the removably mounted cartridge 34 may be used with any type of processing apparatus and its use is not limited to the examples mentioned or discussed in the present application. The cartridge 34 may be used in conjunction with any of the adhesive transfer and/or laminating machines disclosed in U.S. Pat. Nos. 5,584,962 and 5,580,417 and 5,788,806, U.S. patent application of Paque, Ser. No. 09/189,273, U.S. patent application of Velasquez, Ser. No. 09/691,042, U.S. patent application of Miller, Ser. No. 60/236,750, and U.S. Provisional Application of Lemens, Ser. No. 60/248,217, the entirety of each being incorporated into the present application by reference.

The apparatus 36 comprises a frame 58, a feed tray (not shown), an exit tray 60 and an actuator 67 in the form of a crank handle. As previously stated and as best seen in the perspective view of FIG. 5, the apparatus 36 also comprises a pair of cooperating pressure applying structures 38, 40 and a cartridge-receiving opening 62 defined by the frame for removably mounting the cartridge 34.

The materials from the supply rolls 46, 52 are disposed adjacent and in contact with one another before insertion into the cooperating pressure applying structures 38, 40 of the apparatus 36. The removable cartridge body structure 34 is inserted into the cartridge receiving opening 62 of the apparatus 36 so that the supply rolls 38, 40 face inwardly with respect to the frame 58.

FIG. 6 illustrates the cartridge body structure 34 removably mounted within the processing apparatus 36. Then, the selected substrate 26 may be inserted into a feeding opening 63 in the cartridge body structure 34 so as to pass between the lower and upper supply rolls 46, 52. The layer of pressure-sensitive adhesive 16 on the flexible magnet substrate 14 is brought into contact with one surface of the selected substrate 26 and the protecting substrate 48 contacts both the opposing surface of the selected substrate 26 and any excess adhesive exposed about the periphery of the selected substrate 26. Together the flexible magnet substrate 14, the protecting substrate 48 and the selected substrate 26 are advanced through the cooperating pressure applying structures 38, 40 of the apparatus 36, as shown in FIG. 6. The actuator 67 is a crank handle having a shaft 69 extending inwardly through an opening in a side wall to the interior of the apparatus 36 and operatively connects the actuator 67 to the upper cooperating structure 38. As a result, manual rotation of the actuator 67 rotates the upper cooperating structure 38 causing the flexible magnet substrate 14, the selected substrate 26, and the protecting substrate 48 to be fed through the cooperating pressure applying structures 38, 40 with the structures 38, 40 applying pressure thereto.

As the flexible magnet substrate 14, the selected substrate 26, and the protecting substrate 48 are fed through the cooperating pressure applying structures 38, 40, the cooperating pressure applying structures 38, 40 apply pressure to these substrates so a portion of the layer of pressure-sensitive adhesive 16 is adequately adhered to the selected substrate 26 and so that any excess portions of adhesive 16 bond to the protecting substrate 48, if the substrate 48 has an affinity for adhesive bonding. The selected substrate 26, along with the flexible magnet substrate 14 and protecting substrate 48 on the opposing sides thereof, is then discharged out the discharge side of the cooperating pressure applying structures 38, 40 onto the exit tray 60.

After the selected substrate 26, the flexible magnet substrate 14 and protecting substrate 48 have been discharged, the user is able to cut the flexible magnet substrate 14 around the periphery of the selected substrate 26 to separate the completed magnetically mountable adhesive construction 31, as shown in FIG. 4.

The protecting substrate 48 may simply serve to cover the excess adhesive 16 exposed about the periphery of the selected substrate 26 to protect the same from sticking to the pressure applying structures 38, 40 of the apparatus 36. In one embodiment, the surface of the protecting substrate 48 may be release coated to prevent the excess adhesive from sticking thereto. In that event, the protecting substrate 48 is simply peeled away and discarded after being discharged from the apparatus 36. In another embodiment, the surface of the protecting substrate may have an affinity for adhesive bonding and thus any excess adhesive exposed around the periphery of the selected substrate 26 will adhere thereto. In that event, the protecting substrate 48 can be left over the selected substrate 26 and the cutting of the magnet substrate 14 can be spaced from the periphery of the selected substrate, thus leaving a marginal portion of the protecting substrate 48 adhered to a marginal portion of the magnet substrate 14. The protecting substrate should be transparent so that the selected substrate 26 can be viewed. In this arrangement, the protecting substrate 48 protects the selected substrate 26 in much the same fashion as a laminated document. Alternatively, the surface of the protecting substrate 48 that contacts this excess adhesive may have a greater affinity for adhesive bonding than the adhesive carrying surface 18 of the magnet substrate 14. In this arrangement, the excess adhesive will stay on the protecting substrate 48 as it is peeled away from the selected substrate 26, thus stripping the excess adhesive off the magnet substrate 14 for easier handling and subsequent cutting.

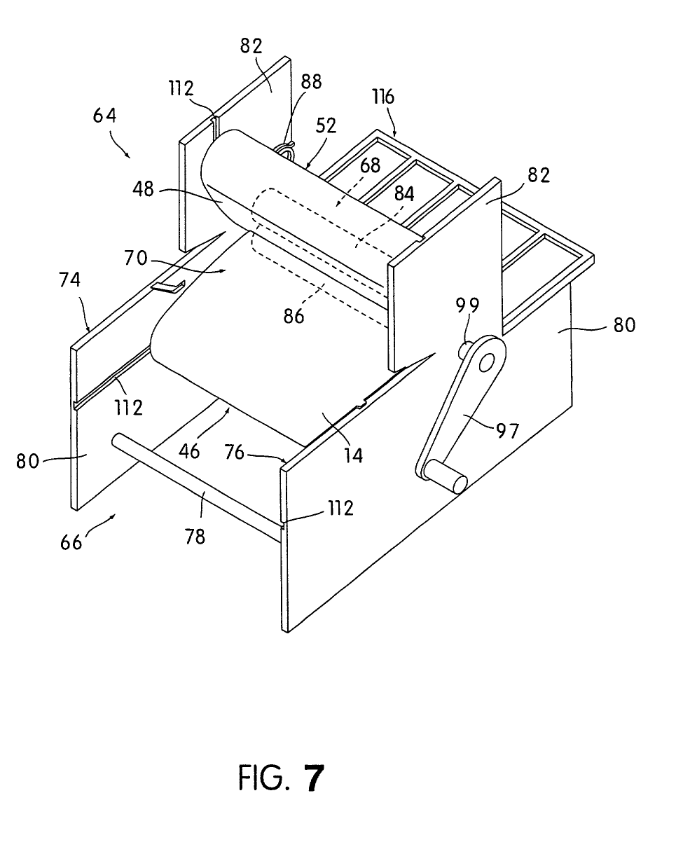

FIG. 7 shows a second embodiment of a processing apparatus with individual feed rolls mounted thereto used to provide more efficient production of such magnetically mountable adhesive constructions. As best shown, a processing assembly, generally indicated at 64, comprises a frame 66, that supports a master processing assembly, generally indicated at 68, a cartridgeless feed roll assembly, generally indicated at 70, and an actuator in the form of a crank handle, generally indicated at 97.

The frame 66 includes a pair of molded plastic side walls 74, 76 disposed parallel to one another in spaced relationship and extending upward in a generally vertical direction. The vertical side walls 74, 76 are secured in spaced relation by a pair of transversely extending spacer rods, one of which is indicated at 78. On the interior of each side wall 74, 76 is an upwardly facing U-shaped receiving slot (not shown) extending from a lower side wall portion 80 to an upper side wall portion 82.

The master processing assembly 68 comprises a pair of cooperating structures 84, 86, in the form of rotatable cooperating pressure applying structures extending transversely between the vertical side walls 74, 76, respectively. The upper cooperating structure 84 extends transversely between the upper side wall portions 82 and is rotatably retained in the U-shaped receiving slot. The lower cooperating structure 86 extends transversely between the lower side wall portions 80 and is rotatably retained below the upper cooperating structure 84 in the U-shaped receiving slot. By extending across the top of the U-shaped slots, the lower leg of each U-shaped spring 88 contacts the axle of the upper cooperating structure 84. The U-shaped spring 88 applies generally downward pressure to the axle to thereby retain the master processing assembly 68 in the upwardly facing U-shaped slots and forcing the peripheral surfaces of the cooperating pressure applying structures 84, 86 in cooperating rolling contact with one another. The upper and lower cooperating structures 84, 86 are preferably designed to engage each other in a rolling relation so as to define a nip area where the upper and lower cooperating structures 84, 86 meet and to exert pressure on substrates or films fed therebetween into the nip area.

The master processing assembly 68 may take any form suitable for applying pressure to substrate materials fed therebetween. For example, one of the rotatable cooperating pressure applying structures may be replaced by a fixed cooperating structure.

The cartridgeless feed roll assembly 70 includes an upper supply feed roll 52 and a lower supply feed roll 46 (also referred to as first and second) each containing stock materials wound around generally cylindrical feed roll cores 44, 12, respectively. The upper supply feed roll 52 contains the supply of protecting substrate 48 wound about its cylindrical core. The lower supply roll 46 contains the flexible magnet substrate 14 having the layer of adhesive 16 and the layer of release material 22 wound about its cylindrical core 12.

Each of the lower and upper feed rolls 46, 52 carry a pair of feed roll mounting structures 90, one on each opposite longitudinal end thereof. These feed roll mounting structures 90 are constructed and arranged to mount the rolls 46, 52 to the frame of the processing apparatus 10, enabling the rolls 46, 52 to be rotated and for the lead end portions 24, 50 of the flexible magnet substrate 14 and the protecting substrate 48, respectively, to be unwound.

The lead end portions 24 and 50 of the stock materials are unwound and fed together between the cooperating structures of the processing assembly. The lead end portions of the stock materials being unwound may be bonded together to form a bonded lead end portion (not shown) prior to delivery to the end user. During operation, the protecting substrate 48 covers the pressure-sensitive adhesive 16 as the substrates are being fed through the pressure applying structures 84, 86 to prevent the adhesive 16 from contacting the cooperating structures 84, 86 and sticking thereto. The selected substrate 26 can then be fed between the lead end portions 24, 50 of the magnet substrate 14 and the protecting substrate 48, respectively.

The processing apparatus 64 also includes the actuator 97. The actuator 97 is a crank handle having a shaft 99 extending inwardly through an opening in side wall 76 to the interior of the apparatus 64 and is connected to the lower cooperating structure 86. Although not shown, the end of the shaft 99 is threaded and the lower cooperating structure 86 has a threaded bore (not shown) that receives the threaded end of the shaft 99, thereby operatively connecting the actuator 97 to the lower cooperating structure 86. As a result, manual rotation of the actuator 97 rotates the lower cooperating structure 86. Alternatively, a power-operated device may be used to affect rotation of the pressure applying structures.

As indicated above, the processing apparatus 64 may be used for multiple purposes including making magnetically mountable adhesive constructions. Also, the apparatus 64 may be any type of master processing apparatus capable of applying pressure or heat to substrates fed into the master processing assembly 68 thereof.

Preferably, the stock materials comprise a protecting substrate and a flexible magnet substrate having a layer of pressure-sensitive adhesive and a release material covering opposite sides thereof. It should be understood that the stock materials may comprise any flexible substrate material with at least one of the stock materials carrying a flexible magnet substrate having a layer of pressure-sensitive on one side thereof.

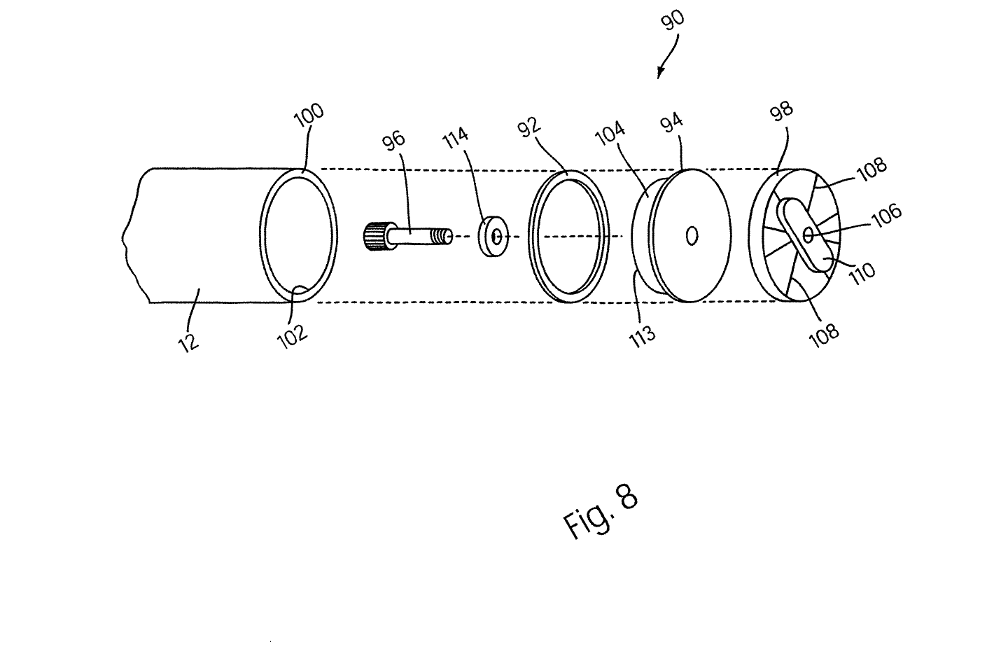

FIG. 8 shows a perspective exploded view of one end of the core 12 having one of the pair of mounting structures 90 in the form of a pre-tensioning brake thereon. The feed roll core 12 is preferably in the form of a cylinder made from plastic or cardboard, having an end face 100 and an interior wall 102. It should be noted that although core 12 is shown in FIG. 8, core 44 may be of similar or the same structure and could also be represented.

Each mounting structure 90 comprises an annular protecting ring 92, a generally cylindrical mounting cap 94, a fastener 96, and an end cap 98. The mounting cap 94 has an interior annular wall 104 and is preferably of molded plastic or other similar material. The interior annular wall 104 of the mounting cap 94 is configured to be positioned slightly inwardly of the end face 100 of the feed roll core 12 and may be adhesively secured in place to the interior wall 102 of the feed roll core 12 thereof. The mounting cap 94 abuts the protecting ring 92, which is preferably made from rubber or a similar material suitable for providing a slight space between the mounting cap 94 and the end face 100 of the core 12.

The circular end cap 98 abuts the mounting cap 94 on the opposite side as the feed roll core 12. The end cap has a central cylindrical aperture 106 configured to receive the threaded shaft of fastener 96. Reinforcing ribs 108 project outwardly from the end cap 98 with a raised mounting projection 110 centrally positioned on the end cap 98 and having the cylindrical aperture 106 therethrough. The raised mounting projections 110 extend outwardly from the lower and upper feed rolls 46, 52 and are constructed and arranged to be slidably received by mounting projection slots 112 on the frame 66.

When the raised mounting projections 110 hold the end cap 98 in a fixed position within the projection slots 112 in the frame 66, both the core 12 and the mounting cap 94 adhered thereto can rotate relative to the end cap 98.

A washer 114 is interposed between the head of the fastener 96 and the mounting cap 94. The fastener 96 is tightened to tightly engage the axial surfaces of the end cap 98 and the mounting cap 94, which is adhered to the core 12, such that friction is generated therebetween as the feed rolls are unwound. This friction retards or pre-tensions the rolls to prevent the substrates from overrunning during the unwinding thereof. This friction or tension is pre-adjusted by the manufacturer to provide the proper roll tension depending upon the type of material, size of the material, thickness of the material and any other possible factors. However, the provision of these structures for creating friction is not required and the invention may be practiced without such structures.

During the manufacturing of the lower and upper feed rolls 46, 52, their respective lead end portions 24, 50 may be adhesively bonded together to form a bonded lead end portion. A fixture with a narrow slot may be used to facilitate such engagement or it may be performed manually. The lead end portions 24, 50 are flushly positioned with one another for feeding between the upper and lower cooperating structures 84, 86 when a user inserts the lead end portion therebetween.

Various substrates may be provided to the user in a ready-to-use cartridgeless feed roll assembly 70 with the cartridgeless feed roll assembly 70 being held together prior to insertion into the processing apparatus 64 with packaging such as cardboard, tape or removable end caps. The user simply selects the appropriate cartridgeless feed roll assembly 70, individually mounts the separate feed rolls 46, 52 to the frame 66 of the apparatus 64 and inserts the lead end portions 24, 50 between the cooperating structures 84, 86 of the master processing assembly 68.

The selected substrate 26 such as a pre-printed card is fed into the nip area of the master processing assembly 68 with the protecting substrate 48 and the flexible magnet substrate 14 on opposing sides thereof. Then, the user can perform the master processing operation at his/her convenience.

Thereafter, a user operates the processing assembly 64 in much the same fashion as the apparatus 36 discussed above. In the operation of the processing assembly 64, rotation of the actuator 97 rotates the lower cooperating structure 86 causing the substrates to be fed through the cooperating structures 84, 86. The substrates are then advanced outwardly from the cooperating structures 84, 86 and onto an exit tray assembly 116. Once the substrates are advanced onto the exit tray assembly 116, the user is able to cut the flexible magnet substrate 14 around the periphery of the selected substrate 26 to separate the completed magnetically mountable adhesive construction 31, as shown in FIG. 4.

The principles of the present invention may also be applied to any type of stock materials or combination thereof, including but not limited to laminating films, adhesive transfer films, adhesive mask films and the like.

It will be thus appreciated that the objectives of the present invention have been fully and effectively accomplished. The foregoing detailed embodiments have been provided to illustrate the functional and structural principles of the present invention and are not intended to be limiting. The contrary, the present invention is intended to cover all modifications, alterations, and substitutions within the spirit and scope of the appended claims.

What is claimed:

1. A device for making a magnetically mountable substrate construction from a selected substrate for magnetic mounting to a structure including magnetizable material, the substrate construction comprising the selected substrate, a carrier portion formed from a flexible magnet substrate including permanently magnetized material, and pressure sensitive adhesive bonding the selected substrate to the carrier portion, said device comprising:
a flexible magnet substrate having an adhesive carrying surface and a release surface opposite said carrying surface, said flexible magnet substrate including permanently magnetized material which enables said flexible magnet substrate to be magnetically mounted to structures including magnetizable material;
a layer of pressure-sensitive adhesive provided on said adhesive carrying surface of said flexible magnet substrate;
said flexible magnet substrate being wound into a roll such that said layer of pressure-sensitive adhesive directly engages the release surface of said flexible magnet substrate;
said adhesive carrying surface having a greater affinity for adhesive bonding than said release surface so as to enable said device to be used to make the magnetically mountable substrate construction comprising the selected substrate, a carrier portion of said flexible magnet substrate, and a portion of said adhesive layer adhesively bonding said selected substrate to said portion of said flexible magnet substrate by (a) unwinding a lead end portion of said flexible magnet substrate with said adhesive remaining bonded to the adhesive carrying surface of the unwound lead end portion, and (b) engaging the selected substrate with the adhesive on said unwound lead end portion and applying pressure to adhesively bond the selected substrate to said unwound lead end portion, and (c) cutting the unwound lead end portion so as to form said carrier portion.

2. A device according to claim 1, further comprising a core, said magnet substrate being wound about said core such that said layer of adhesive directly engages the release surface of said flexible magnet substrate.

3. A device according to claim 2, further comprising a layer of release material coated on the release surface of said flexible magnet substrate to provide said release surface with a lower affinity for adhesive bonding than said adhesive carrying surface.

4. A device according to claim 3, wherein said release material comprises silicone.

5. A device according to claim 3, wherein said adhesive carrying surface of said flexible magnet substrate is uncoated.

6. A device according to claim 2, wherein said pressure-sensitive adhesive is an emulsion-based acrylic adhesive.

7. A device according to claim 2, wherein said magnetic material comprises a plurality of rare earth particles and wherein said flexible magnet substrate is formed from a flexible matrix material having said rare earth particles embedded therein.

8. A device according to claim 7, wherein said matrix material is rubber.

9. A device according to claim 2, further comprising:
a cartridge body structure constructed and arranged to be removably mounted to a processing apparatus having cooperating pressure applying structures operable to apply pressure to substrates fed therebetween;
said core being rotatably mounted to said cartridge body structure to enable the lead end portion to be unwound and fed in between the pressure applying structures of the processing apparatus;
a second core;
a flexible protecting substrate wound about said second core, said second core being rotatably mounted to said cartridge body structure so as to enable a lead end portion of said protecting substrate to be unwound and fed between the pressure applying structures of the processing apparatus along with said flexible magnet substrate so that said protecting substrate covers any exposed portions of the adhesive layer to prevent said exposed portions from contacting to the cooperating pressure applying structures.

10. A device according to claim 2, wherein said core has mounting structure on the ends thereof constructed and arranged to be mounted to a frame of a processing apparatus, the apparatus including cooperating pressure applying structures operable to apply pressure to substrates fed therebetween.

11. A method for making a magnetically mountable adhesive construction from a selected substrate for magnetic mounting to a structure including magnetizable material, said substrate construction comprising the selected substrate, a carrier portion formed from a flexible magnet substrate including permanently magnetized material, and pressure-sensitive adhesive adhesively bonding the selected substrate to said carrier portion, said method comprising:
providing a device comprising:
a flexible magnet substrate having an adhesive carrying surface and a release surface opposite said carrying surface, said flexible magnet substrate including magnetized material which enables said flexible magnet substrate to be magnetically mounted to structures including magnetizable material;
a layer of pressure-sensitive adhesive provided on said adhesive carrying surface of said flexible magnet substrate;
said flexible magnet substrate being wound into a roll such that said pressure-sensitive adhesive layer directly engages the release surface of said flexible magnet substrate;
said adhesive carrying surface having a greater affinity for adhesive bonding than said release surface to enable a lead end portion of said flexible magnet substrate to be unwound with the adhesive remaining bonded to the adhesive carrying surface of said unwound lead end portion;
unwinding the lead end portion of said flexible magnet substrate with the adhesive remaining bonded to the adhesive carrying surface of said unwound lead end portion;
engaging the selected substrate with the adhesive on the unwound lead end portion of said flexible magnet substrate;
applying pressure to adhesively bond the selected substrate to said unwound lead end portion; and
cutting said unwound lead end portion of said flexible magnet substrate so as to form said carrier portion.

12. A method according to claim 11, wherein engaging the selected substrate with the adhesive is performed prior to cutting said unwound lead end portion so as to form said carrier portion.

13. A method according to claim 11, wherein engaging the selected substrate with the adhesive is performed after cutting said unwound lead end portion so as to form said carrier portion.

14. A method according to claim 11, wherein said device comprises a core, said magnet substrate being wound about said core such that said layer of adhesive directly engages the release surface of said flexible magnet substrate.

15. A method according to claim 14, further comprising:
providing a master processing assembly comprising a pair of cooperating pressure applying structures constructed and arranged to apply pressure to substrate fed therebetween;
mounting said core to a frame of said processing assembly so as to enable said core to be rotated to provide for unwinding of said lead end portion of said flexible magnet substrate;
providing a second core having a flexible protecting substrate wound thereon;
mounting said second core to the frame of said processing assembly so as to enable said second core to be rotated to provide for unwinding of a lead end portion of said protecting substrate;
unwinding said lead end portion of said protecting substrate;
feeding said lead end portion of said magnet substrate and said lead end portion of said protecting substrate together between said cooperating structures of said processing assembly such that said protecting layer covers said layer of adhesive to prevent said adhesive from contacting said cooperating structures;
feeding said selected substrate between said lead end portions of said magnet substrate and said protecting substrate;
then actuating said cooperating structures such that cooperating structures apply said sufficient pressure to said protecting substrate, said selected substrate, and said magnet substrate so as to cause said adhesive to adhesively bond the selected substrate to said unwound lead end portion of said magnet substrate and thereafter advance said substrates outwardly from said cooperating structures.

16. A method according to claim 15, wherein said cores are rotatably mounted to a cartridge body structure such that mounting said cores to said processing assembly is performed simultaneously by removably mounting said cartridge body structure to the frame of said processing assembly.

17. A method according to claim 15, wherein said cores are separate from one another and individually mount to the frame of said processing apparatus.
